(19) United States
(12) Patent Application Publication
(10) Pub. No.: US 2006/0293009 A1
(43) Pub. Date: Dec. 28, 2006

(54) AGC Circuit

(75) Inventor: Kazuyuki Kobayashi, Midori-shi (JP)

Correspondence Address: FISH & RICHARDSON P.C., P.O. BOX 1022, MINNEAPOLIS, MN, 55440-1022, US

(73) Assignee: SANYO ELECTRIC CO., LTD., Osaka (JP)

(21) Appl. No.: 11/425,910

(22) Filed: Jun. 22, 2006

(30) Foreign Application Priority Data
Jun. 24, 2005 (JP) 2005-185345

(51) Int. Cl. H04B 1/06; H04B 7/00

(52) U.S. Cl. 455/232.1

(57) ABSTRACT

An AGC circuit comprises a variable gain amplifier that has a gain set variably and amplifies an input signal with the gain; a detection circuit that detects an output signal amplified by the variable gain amplifier; an error amplifier that outputs an error voltage corresponding to a difference voltage between a detected voltage indicating amplitude of the detected output signal and a reference voltage for fixing the amplitude of the output signal to be at a predetermined degree; a capacitor that is charged depending on the error voltage and holds a setting voltage for fixing the gain of the variable gain amplifier to be constant that is applied to a gain setting input of the variable gain amplifier; and a charging switch circuit that is closed to permit charging the capacitor until the charged voltage of the capacitor reaches the setting voltage and is opened to forbid charging the capacitor after the charged voltage reaches the setting voltage.

### CROSS-REFERENCE TO RELATED APPLICATIONS

This application claims priority from Japanese Patent Application No. 2005-185345, filed on Jun. 24, 2005, which is herein incorporated by reference.

### BACKGROUND OF THE INVENTION

1. Field of the Invention

The present invention relates to an AGC circuit.

2. Description of the Related Art

In general, an AGC (Automatic Gain Control) circuit performs control such that negative feedback is applied to a gain of an amplification circuit to make amplitude of its output signal constant regardless of fluctuations of amplitude of its input signal. That is, the AGC circuit is a circuit that reduces the gain of the amplification circuit when the amplitude of the input signal is greater than a predetermined value and increases the gain of the amplification circuit when the amplitude of the input signal is smaller than the predetermined value. Such an AGC circuit is applied to an AM receiver, etc., that prevent fluctuations of the electric wave intensity from appearing in the audio output, for example.

Description will be made below of the configuration of a typical AGC circuit shown in FIG. 6.

A variable gain amplification circuit (VGA (Variable Gain Amplifier)) 101 is an amplification circuit having a gain that can be varied by applying a detected voltage det_out output from a detection circuit 103 described later. The variable gain amplification circuit 101 amplifies an input signal (alternating-current signal) vga_in with a set gain to output an amplified signal amp_in. An amplification circuit 102 is disposed at the stage after the variable gain amplification circuit 101 and further amplifies the amplified signal amp_in with a gain fixed in advance to output an output signal det_in. The output signal det_in of the amplification circuit 102 needs to have such amplitude as to enable the output signal det_in to be processed normally by a circuit block (not shown) disposed at the stage after the AGC circuit of FIG. 6. Accordingly, the amplification circuit 102 is set to have such a gain that the output signal det_in has enough amplitude to be processed normally by the circuit block at the subsequent stage. However, if the variable gain amplification circuit 101 can set a gain that can make the amplitude of the amplified signal amp_in equal to the amplitude of the output signal det_in, the amplification circuit 102 can be omitted. The detection circuit 103 integrates the output signal det_in and outputs a detected voltage det_out in the form of a direct-current voltage indicating the degree of the amplitude of the output signal det_in. The detection circuit 103 is composed of, for example, a diode 103a and a capacitor 103b for smoothing the output signal det_in, and the detected voltage det_out is output from the nongrounded end of the capacitor 103b. This detected voltage det_out is applied to a gain setting input provided in the variable gain amplification circuit 101. By this means, the gain of the variable gain amplification circuit 101 is changed by the negative feedback action corresponding to the level of the detected voltage det_out so as to make the amplitude of the output signal det_in constant.

Such a conventional AGC circuit is disclosed in Japanese Patent Application Laid-Open Publication No. H06-78241, for example.

However, since the AGC circuit of FIG. 6 performs the negative feedback control to make the amplitude of the output signal det_inconstant, for example, if the AGC circuit receives a signal having information in its amplitude, such as an ASK (Amplitude Shift Keying) modulated signal, it is problematic that the amplitude is not reflected in the output signal det_in. This problem will be described below with reference to FIGS. 6 and 7. FIG. 7 is a waveform diagram of relevant waveforms when an ASK modulated signal is input into the AGC circuit of FIG. 6.

First, when an ASK modulated signal vin is received with an antenna 104, this ASK modulated signal vin is input as an input signal vga_in to the variable gain amplification circuit 101. The gain of the variable gain amplification circuit 101 is determined corresponding to the detected voltage det_out of the detection circuit 103 that detects the output signal det_in output from the amplification circuit 102 at the rear stage. That is, the input signal vga_in is amplified with the current gain of the variable gain amplification circuit 101 to be the amplified signal amp_in. The amplified signal amp_in is amplified with the fixed gain of the amplification circuit 102 to be the output signal det_in. The output signal det_in is input to the circuit block at the subsequent stage and is also input to the detection circuit 103.

For example, if the amplitude of the output signal det_in input to the detection circuit 103 is greater than a predetermined value, the detected voltage det_out from the detection circuit 103 becomes a high-level as compared to the detected voltage det_out when the amplitude of the output signal det_in is equal to the predetermined value. The high-level detected voltage det_out is applied to the gain setting input, and the gain of the variable gain amplification circuit 101 is reduced to make the amplitude of the output signal det_in constant. Consequently, the gain of the variable gain amplification circuit 101 is set to be smaller than the gain for when the amplitude of the output signal det_in is equal to the predetermined value. The input signal vga_in is amplified with the smaller gain of the variable gain amplification circuit 101 to be the amplified signal amp_in. On the other hand, if the amplitude of the output signal det_in input to the detection circuit 103 is smaller than the predetermined value, the detected voltage det_out from the detection circuit 103 becomes a low-level as compared to the detected voltage det_out when the amplitude of output signal det_in is equal to the predetermined value. The low-level detected voltage det_out is applied to the gain setting input, and the gain of the variable gain amplification circuit 101 is increased to make the amplitude of the output signal det_in constant. Consequently, the gain of the variable gain amplification circuit 101 is set to be greater than the gain for when the amplitude of the output signal det_in is equal to the predetermined value. The input signal vga_in is amplified with the greater gain of the variable gain amplification circuit 101 to be the amplified signal amp_in. Since a loop is formed for the negative feedback in the AGC circuit, a delay time is generated by the output of the variable gain amplification circuit 101 and the amplification circuit 102, and the detection in the detection circuit 103. Therefore, the variable gain amplification circuit 101 amplifies the input signal vga_in at the timing delayed by the delay time.

Consequently, since the input signal vga_in becomes the amplified signal amp_in with a waveform shown in FIG. 7, the information included in the amplitude of the input signal vga_in may not be transmitted to the amplification circuit 102 at the rear stage. The output signal det_in based on the amplified signal amp_in may not transmit the information included in the amplitude of the input signal vga_in to the circuit block at the subsequent stage, either. Therefore, a normal signal process may not be performed at the subsequent stage. Alternatively, an erroneous signal process may be performed in the circuit block.

### SUMMARY OF THE INVENTION

An object of the present invention is to provide an AGC circuit that fixes its gain such that the amplitude of an input signal becomes necessary amplitude.

In order to solve the above problem, according to the present invention there is provided an AGC circuit which comprises a variable gain amplification circuit that has a gain set variably and amplifies an input signal with the gain; a detection circuit that detects an output signal amplified by the variable gain amplification circuit; an error amplification circuit that outputs an error voltage corresponding to a difference voltage between a detected voltage indicating amplitude of the output signal detected by the detection circuit and a reference voltage for fixing the amplitude of the output signal to be at a predetermined degree; a capacitor that is charged depending on the error voltage and holds a setting voltage for fixing the gain of the variable gain amplification circuit to be at a constant value, the setting voltage being applied to a gain setting input of the variable gain amplification circuit; and a charging switch circuit that is closed to permit an operation of charging the capacitor until a charged voltage of the capacitor reaches the setting voltage and is opened to forbid the operation of charging the capacitor after the charged voltage of the capacitor reaches the setting voltage.

Features and objects of the present invention other than the above will become apparent from the description of this specification and the accompanying drawings.

### BRIEF DESCRIPTION OF THE DRAWINGS

To understand the present invention and the advantages thereof more thoroughly, the following description should be referenced in conjunction with the accompanying drawings.

FIG. 1 is a block diagram of an example of an AGC circuit 25 and its peripheral configuration according to the present invention;

FIG. 2 shows a trimming resistor that generates a reference voltage Vref;

FIG. 3 shows a clock extraction circuit that extracts clocks from an ASK modulated signal;

FIG. 4 is a timing chart of the operations of the AGC circuit 25 and the peripheral configuration according to the present invention;

FIG. 5 is a waveform diagram of relevant waveforms when the ASK modulated signal is input to the AGC circuit 25 according to the present invention;

FIG. 6 is a block diagram of the configuration of a typical AGC circuit;

FIG. 7 is a waveform diagram of relevant waveforms when the ASK modulated signal is input into the typical AGC circuit; and

FIG. 8 is a schematic diagram of a passive keyless entry system to which the AGC circuit 25 according to the present invention is applied.

### DETAILED DESCRIPTION OF THE INVENTION

From the contents of the description and the accompanying drawings, at least the following details will become apparent.

==Overall Configuration of AGC Circuit==

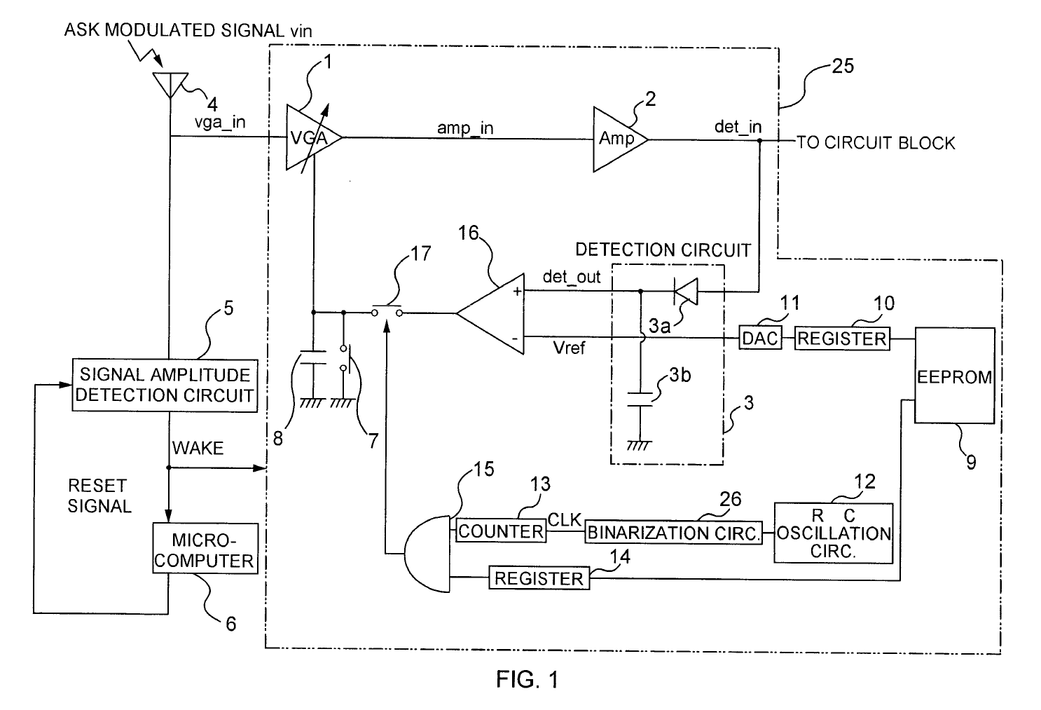

Description will be made of the overall configuration of an AGC circuit 25 according to the present invention with reference to FIGS. 1 and 5. FIG. 1 is a block diagram of an example of an AGC circuit 25 (chain double-dashed line) and its peripheral configuration (signal amplitude detection circuit 5, etc.) according to the present invention. FIG. 5 is a waveform diagram of relevant waveforms when an ASK modulated signal is input to the AGC circuit 25 according to the present invention. In FIG. 1, the AGC circuit 25 includes an EEPROM (Electronically Erasable and Programmable Read Only Memory) 9 (nonvolatile memory), a register 10, a DAC 11, an RC oscillation circuit 12, a binarization circuit 26, a counter 13, a register 14 (comparison register), and a coincidence detection circuit 15, but is not limited to this. For example, the components may be provided in the peripheral configuration of the AGC circuit 25 and the AGC circuit 25 may be constituted by the remaining components. In the description below, the AGC circuit 25 in this embodiment is assumed to operate for processing an ASK modulated signal vin shown in FIG. 5, for example. In the description below, the ASK modulated signal vin is assumed to be constituted by a header where amplitude of a predetermined level (e.g., 200 mVPP) or greater continues, e.g., for 10 msec (t0 to t1), and a data portion with a length of 90 msec (t1 to t2) where information is included in the form of changes in amplitude.

An antenna 4 receives an ASK modulated signal vin. The ASK modulated signal vin is input to the signal amplitude detection circuit 5 and the AGC circuit 25 as an input signal vga_in (alternating-current signal).

The signal amplitude detection circuit 5 determines whether or not the beginning of the header of the input signal vga_in has amplitude of a predetermined level or greater. In a period when it is determined that the beginning of the header of the input signal vga_in is not at the predetermined level or greater in amplitude, the signal amplitude detection circuit 5 outputs a WAKE signal of a high level to the AGC circuit 25 and a microcomputer 6 so as to have the AGC circuit 25 and the microcomputer 6 not operate. If it is determined that the beginning of the header of the input signal vga_in is at the predetermined level or greater in amplitude, the signal amplitude detection circuit 5 outputs the WAKE signal of a low level (an operation start signal) to the AGC circuit 25 and the microcomputer 6 so as to have the AGC circuit 25 and the microcomputer 6 operate. When a reset signal of a low level is input from the microcomputer 6, the signal amplitude detection circuit 5 outputs the WAKE signal of a high level to the AGC circuit 25 and the microcomputer 6 again. In this embodiment, the signal amplitude detection circuit 5 outputs the WAKE signal of a low level immediately after it is determined that the beginning of the header of the input signal vga_in is at the predetermined level or greater, although this is not a limitation. For example, the signal amplitude detection circuit 5 may be arranged to output the low-level WAKE signal when the amplitude of the predetermined level or greater is input for a predetermined period from the beginning of the header. As a result, the process described below can be performed more certainly only for the input signal vga_in having the header where the amplitude is continued to be at the predetermined level or greater. For example, the signal amplitude detection circuit 5 may be prevented from outputting the low-level WAKE signal when the antenna 4 receives a signal different from the ASK modulated signal vin, which signal is at the predetermined level or greater in amplitude for a period shorter than the predetermined period.

When the low-level WAKE signal is input from the signal amplitude detection circuit 5, the microcomputer 6 starts a timer (not shown) clocking. The microcomputer 6 determines whether or not the clocking of the timer attains a communication period of the ASK modulated signal vin (between t0 and t2, for example, 10 msec+90 msec=100 msec). When it is determined that the clocking of the timer attains 100 msec, the microcomputer 6 outputs the reset signal of a low level to the signal amplitude detection circuit 5.

When the low-level WAKE signal is input from the signal amplitude detection circuit 5, the AGC circuit 25 is turned on and becomes operable. For example, a switch element (not shown) such as a transistor exists between a power supply line that applies a power supply voltage for operating the AGC circuit 25 and a power supply line for the components of the AGC circuit 25, and the AGC circuit 25 is made operable by turning on the switch element according to the low-level WAKE signal.

A switch circuit 7 (a discharging switch circuit) is connected at one end to a nongrounded end of a capacitor 8 and is grounded at the other end. For example, the switch circuit 7 is constituted by a transistor. The switch circuit 7 is closed for a predetermined time in the initial operation of the AGC circuit 25, and the electric charge of the capacitor 8 is discharged through the switch circuit 7.

A variable gain amplification circuit 1 is an amplification circuit having a gain that can be varied by applying a charging voltage of the capacitor 8. The variable gain amplification circuit 1 amplifies the input signal vga_in with a set gain to output an amplified signal amp_in. For example, the variable gain amplification circuit 1 has a characteristic that the gain decreases as the charging voltage of the capacitor 8 increases. The variable gain amplification circuit 1 also has a characteristic that the gain increases as the charging voltage of the capacitor 8 decreases. How the gain of the variable gain amplification circuit 1 changes is not limited thereto. For example, ±input terminals of a differential amplification circuit 16 (an error amplification circuit) may be inverted so that the gain increases as the charging voltage of the capacitor 8 increases and the gain decreases as the charging voltage decreases.

The amplification circuit 2 is disposed at the stage after the variable gain amplification circuit 1. The order of the amplification circuit 2 and the variable gain amplification circuit 1 maybe reversed. The amplification circuit 2 further amplifies the amplified signal amp_in with a gain fixed in advance and outputs an output signal det_in to a circuit block at the subsequent stage (not shown) and a detection circuit 3. The output signal det_in of the amplification circuit 2 needs to have such amplitude as to enable the output signal det_in to be processed normally by the circuit block. Accordingly, the amplification circuit 2 has such a gain that the output signal det_in has enough amplitude to be processed normally by the circuit block. However, if the variable gain amplification circuit 1 can set a gain that can make the amplitude of the amplified signal amp_in equal to the amplitude of the output signal det_in, the amplification circuit 2 can be omitted.

The detection circuit 3 integrates the output signal det_in and outputs a detected voltage det_out in the form of a direct-current voltage indicating the degree of the amplitude of the output signal det_in. The detection circuit 3 is composed of, for example, a diode 3a and a capacitor 3b for smoothing the output signal det_in and the detected voltage det_out is output from a nongrounded end of the capacitor 3b.

The differential amplification circuit 16 amplifies a difference voltage between the detected voltage det_out input to the +input terminal and a later-mentioned reference voltage Vref input to the −input terminal and outputs an error voltage.

The EEPROM 9 reads data (hereinafter, reference voltage data) stored in a predetermined address indicated by an address register (not shown) in the initial operation of the AGC circuit 25. The reference voltage data is stored in the register 10. The reference voltage data is set such that the amplitude of the output signal det_in from the amplification circuit 2 is at a desired level. Specifically, when a switch circuit 17 (charging switch circuit) is closed, the detected voltage det_out of the detection circuit 3 is made equal to the reference voltage Vref corresponding to the reference voltage data by the negative feedback control of the AGC circuit 25. As a result, the amplification circuit 2 outputs an output signal det_in of such a constant amplitude that the detected voltage det_out becomes equal to the reference voltage Vref. That is, the output signal det_in can be controlled with the reference voltage data to have such amplitude (desired amplitude) as to enable the normal signal process in the circuit block at the stage after the amplification circuit 2.

The EEPROM 9 reads data (hereinafter, comparison data) stored in an address different from the aforementioned predetermined address indicated by the address register in the initial operation of the AGC circuit 25. The comparison data is stored in the register 14. For example, the comparison data corresponds to a value (hereinafter, a setting value) obtained by dividing the header period (t0 to t1) of the ASK modulated signal by the cycle of a clock from the binarization circuit 26. However, this is not a limitation. For example, if the period when the detected voltage det_out is equal to the reference voltage Vref is set shorter than the header period via a time constant, etc., of the capacitor 8 described later, the comparison data may be a value obtained by dividing the period when they are equal by the clock cycle. As a result, since the AGC circuit 25 can prepare to read information from the data portion during a period after the period when equal until the data portion is input, the process can be performed more reliably. The reference voltage data and the comparison data can be rewritten, for example, by a ROM writer. For example, if the period of the header of the ASK modulated signal needs to be changed to 20 msec, the comparison data can be rewritten to be a value obtained by dividing the 20 msec by the clock cycle. If the amplitude of the output signal det_in needs to be changed, the reference voltage data can be rewritten to be a value corresponding to the level of the amplitude. As a result, the AGC circuit 25 can be made general purposed.

The DAC 11 performs a digital-analog conversion process on the reference voltage data stored in the register 10 and outputs the process result, i.e., the reference voltage Vref to the −input terminal of the differential amplification circuit 16.

The RC oscillation circuit 12 oscillates at a predetermined frequency by applying a voltage to the power supply line of the RC oscillation circuit 12 according to the low-level WAKE signal. Although the RC oscillation circuit 12 is used in the embodiment, this is not a limitation. The RC oscillation circuit 12 is used in the embodiment because the RC oscillation circuit 12 has a period from power-on to the steady oscillation shorter than other oscillation circuits. The binarization circuit 26 is constituted by a comparator circuit, for example, and generates a clock signal (CLK) from the oscillation of the RC oscillation circuit 12 at a predetermined frequency. The counter 13 resets its count value in the initial operation of the AGC circuit 25. The counter 13 counts the rising edges of the clocks from the binarization circuit 26.

The coincidence detection circuit 15 determines whether the count value of the counter 13 is equal to a setting value indicated by the comparison data or not. The coincidence detection circuit 15 can be achieved by AND gates, for example. For example, if the numbers of bits of the counter 13 and the register 14 are four, the coincidence detection circuit 15 can be achieved by providing four AND gates to which the value of each bit is input and an AND gate to which the outputs of the four AND gates are input. The coincidence detection circuit 15 outputs a signal for closing the switch circuit 17 (hereinafter, a close signal) to the switch circuit 17 for a period when it is determined that the count value and the setting value do not coincide. When it is determined that the count value and the setting value coincide, the coincidence detection circuit 15 outputs a signal for opening the switch circuit 17 (hereinafter, an open signal) to the switch circuit 17. In a period when the count value is equal to or greater than the setting value, for example, the open signal from the coincidence detection circuit 15 may be output continuously to the switch circuit 17. Alternatively, for example, an RS flip-flop (not shown) or a register (not shown) may be disposed between the coincidence detection circuit 15 and the switch circuit 17 to retain and output the open signal from the coincidence detection circuit 15.

The switch circuit 17 is connected at one end to the output of the differential amplification circuit 16 and is connected at the other end to the nongrounded side of the capacitor 8 and the gain setting input of the variable gain amplification circuit 1. For example, the switch circuit 17 is constituted by a transistor. The control electrode of the switch circuit 17 is controlled by the signal from the coincidence detection circuit 15. That is, the switch circuit 17 is closed according to the close signal and opened according to the open signal from the coincidence detection circuit 15. The switch circuit 17 is closed in the initial operation of the AGC circuit 25.

The capacitor 8 is connected at one end to the other end of the switch circuit 17 and the gain setting input of the variable gain amplification circuit 1 and is grounded at the other end. When the switch circuit 17 is closed, the capacitor 8 is charged depending on the error voltage from the differential amplification circuit 16 and applies the charge voltage to the gain setting input of the variable gain amplification circuit 1. When the switch circuit 17 is opened, the capacitor 8 applies a charged voltage to the gain setting input of the variable gain amplification circuit 1. The capacity of the capacitor 8 is set taking into account the communication period of the ASK modulated signal (t0 to t2), a leak current of the capacitor 8 itself, etc. That is, the capacity of the capacitor 8 is set such that the charged voltage in the header period (t0 to t1) of the ASK modulated signal can be retained during the data portion period (t1 to t2).

==Operation of AGC Circuit==

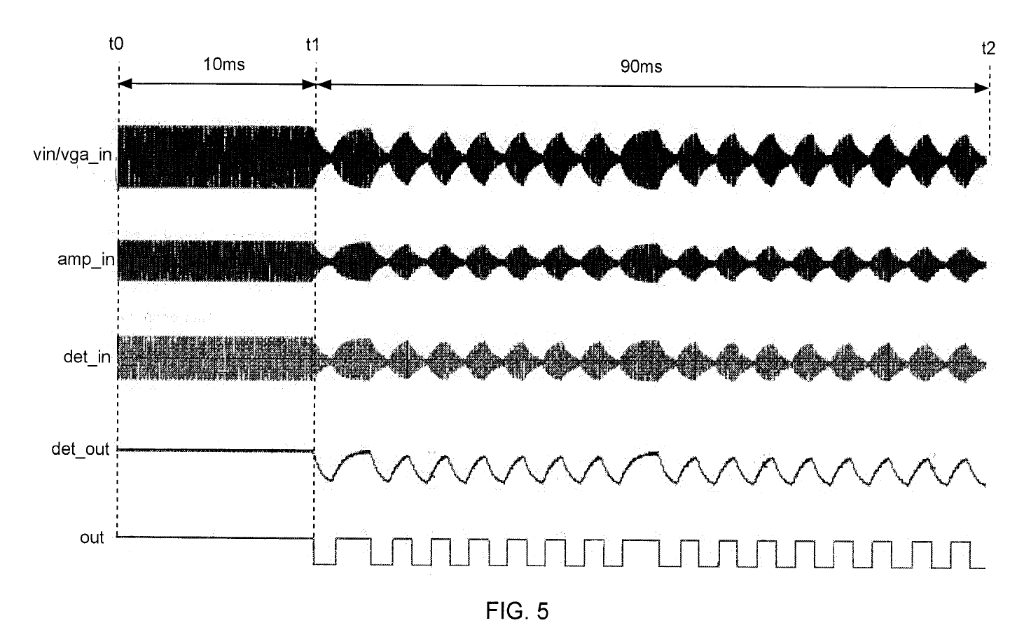

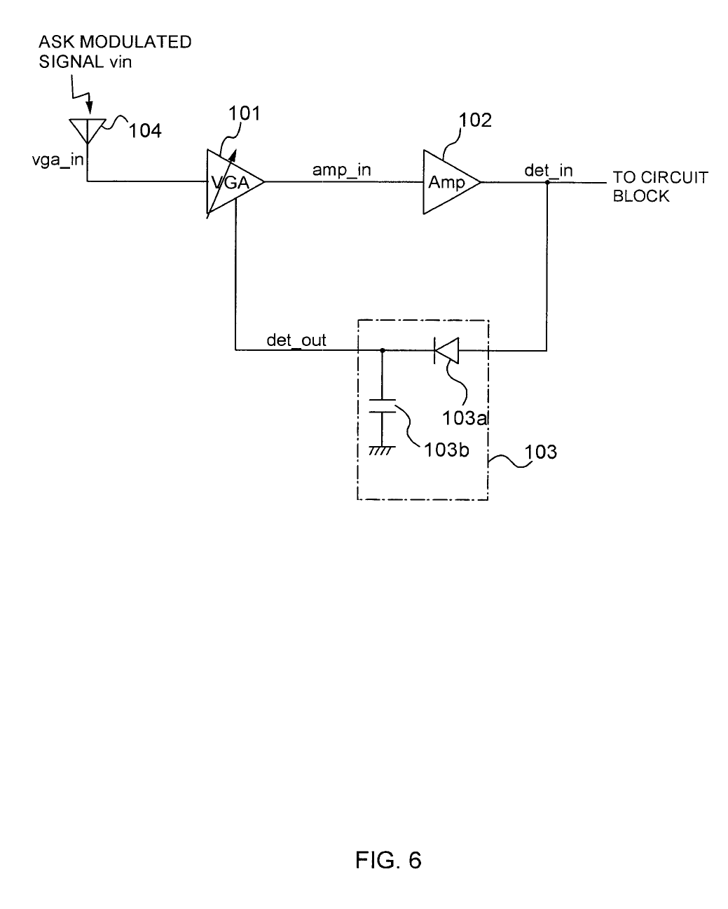

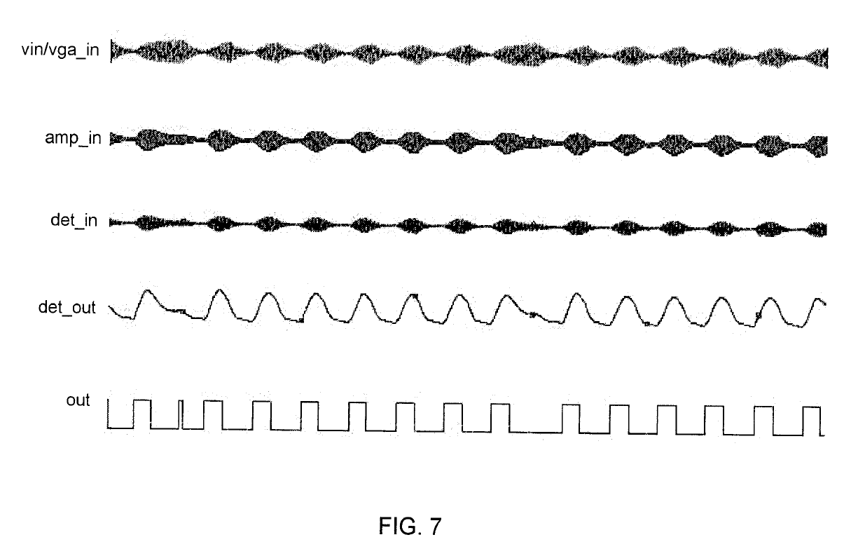

Description will be made of the operation of the AGC circuit 25 according to the present invention with reference to FIGS. 1, 4, and 5. FIG. 4 is a timing chart of the operations of the AGC circuit 25 and the peripheral configuration according to the present invention.

<Initial Operation of AGC Circuit 25>

First, description will be made of the initial operation of the AGC circuit 25.

When the ASK modulated signal vin is received by the antenna 4, the ASK modulated signal vin is input to the signal amplitude detection circuit 5 and the AGC circuit 25 as an input signal vga_in. If it is determined that the beginning of the header of the input signal vga_in has amplitude of a predetermined level or greater, the signal amplitude detection circuit 5 outputs the low-level WAKE signal to the microcomputer 6 and the AGC circuit 25 (t0). When the low-level WAKE signal is input from the signal amplitude detection circuit 5, the microcomputer 6 has the timer start counting and determines whether or not the time count has attained the communication period (t0 to t2) of the ASK modulated signal vin.

When the low-level WAKE signal is input from the signal amplitude detection circuit 5, the AGC circuit 25 is turned on and becomes operable. First, the switch circuit 7 is closed for a certain period and the voltage of the capacitor 8 is discharged. After the certain period, the switch circuit 7 is opened. Further, the counter value of the counter 13 is reset. The RC oscillation circuit 12 oscillates at a predetermined frequency by applying a voltage according to the low-level WAKE signal. The binarization circuit 26 generates clocks from the oscillation of the RC oscillation circuit 12 of a predetermined frequency. The comparison data stored at the address indicated by the address register of the EEPROM 9 is stored into the register 14. The reference voltage data stored at a predetermined address indicated by the address register of the EEPROM 9 is stored into the register 10. Further, the switch circuit 17 is closed.

<Operation of AGC Circuit 25 in Header Period>

Description will be made of the operation of the AGC circuit 25 in the header period (t0 to t1).

The input signal vga_in is amplified with the current gain of the variable gain amplification circuit 1 to be the amplified signal amp_in. The amplified signal amp_in is amplified with the fixed gain of the amplification circuit 2 to be the output signal det_in. The output signal det_in is input to the circuit block at the subsequent stage and the detection circuit 3. The output signal det_in is integrated by the detection circuit 3 to be the detected voltage det_out indicating the degree of the amplitude of the output signal det_in. The detected voltage det_out is input to the +input terminal of the differential amplification circuit 16. The reference voltage data stored in the register 10 is digital-analog converted into the reference voltage Vref, which is input to the −input terminal of the differential amplification circuit 16. The differential amplification circuit 16 amplifies the difference voltage between the detected voltage det_out and the reference voltage Vref and outputs the error voltage.

The counter 13 counts, for example, the rising edges of the clocks from the binarization circuit 26. The coincidence detection circuit 15 determines that the count value of the counter 13 is not equal to the setting value indicated by the comparison data of the register 14 and outputs the close signal to the switch circuit 17. The switch circuit 17 is kept closed while the close signal is applied thereto. Consequently, the capacitor 8 is charged depending on the error voltage from the differential amplification circuit 16. The charged voltage of the capacitor 8 is applied to the gain setting input of the variable gain amplification circuit 1 and the gain is set depending on the charged voltage. The input signal vga_in is amplified by the set gain to be the amplified signal amp_in.

With such a negative feedback control of the AGC circuit 25, the detected voltage det_out of the detection circuit 3 is made equal to the reference voltage Vref. The amplification circuit 2 outputs the output signal det_in of such a constant amplitude that the detected voltage det_out is equal to the reference voltage Vref to the circuit block at the subsequent stage and the detection circuit 3. The charged voltage of the capacitor 8 becomes a constant voltage (set voltage) for when the detected voltage det_out is equal to the reference voltage Vref.

When it is determined that the count value of the counter 13 coincides with the setting value indicated by the comparison data of the register 14, the coincidence detection circuit 15 outputs the open signal to the switch circuit 17. The switch circuit 17 is opened according to the open signal (t1). As a result, the error voltage from the differential amplification circuit 16 is no longer applied to the capacitor 8. The aforementioned constant voltage that has been charged in the capacitor 8 during the header is continuously applied to the gain setting input of the variable gain amplification circuit 1. That is, the gain of the variable gain amplification circuit 1 is fixed at a constant value.

<Operation of AGC Circuit 25 in Data Portion Period>

Description will be made of the operation of the AGC circuit 25 in the data portion period (t1 to t2).

The input signal vga_in is amplified with the constant gain of the variable gain amplification circuit 1 to be the amplified signal amp_in. As a result, the negative feedback control of the AGC circuit 25 is not performed during the data portion including information in terms of changes in amplitude, and the amplified signal amp_in that has been amplified only in the amplitude is output to the amplification circuit 2. Then, the amplified signal amp_in is amplified with the fixed gain of the amplification circuit 2 to be the output signal det_in. The output signal det_in is input to the circuit block at the subsequent stage and the detection circuit 3. As a result, the data portion including information in terms of changes in amplitude is processed by the circuit block without losing the information. Although the error voltage corresponding to the difference voltage between the output signal det_in from the detection circuit 3 and the reference voltage Vref is output from the differential amplification circuit 16, since the switch circuit 17 is open as mentioned above, the charged voltage of the capacitor 8 remains constant.

When it is determined that the time count of the timer has attained the communication period of the ASK modulated signal vin, the microcomputer 6 outputs the reset signal of the low level to the signal amplitude detection circuit 5 (t2). When the low-level reset signal is input from the microcomputer 6, the signal amplitude detection circuit 5 outputs the high-level WAKE signal again to the AGC circuit 25 and the microcomputer 6. As a result, the operations of the microcomputer 6 and the AGC circuit 25 are terminated.

==Example Application of AGC Circuit==

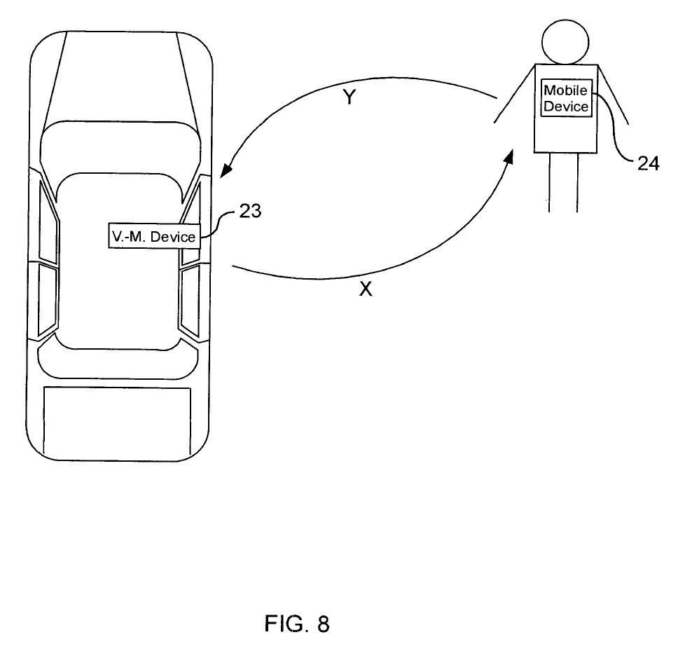

Description will be made of an example application of the AGC circuit 25 according to the present invention with reference to FIG. 8. FIG. 8 is a schematic diagram of a passive keyless entry system where the AGC circuit 25 is applied to a mobile device 24. In the passive keyless entry system, first, a signal X transmitted from a vehicle-mounted device 23 is received by the mobile device 24. Based on the signal X, a signal Y is transmitted from the mobile device 24 to the vehicle-mounted device 23. The vehicle-mounted device 23 determines whether the signal Y is authentic or not, and if it is determined that the signal Y is authentic, for example, the system releases the lock of the vehicle equipped with the vehicle-mounted device 23.

An ASK modulated signal is used for the signal X from the vehicle-mounted device 23 to the mobile device 24. This is because the circuit configurations are simplified of a transmitting unit (not shown) for transmitting the signal X of the vehicle-mounted device 23 and of the mobile device 24 for receiving the signal X and because the vehicle-mounted device 23 can communicate with the mobile device 24 even when some degree of interference exists. Furthermore, an FSK (Frequency Shift Keying) modulated signal, e.g., is used for the signal Y from the mobile device 24 to the vehicle-mounted device 23. This is because the FSK modulated signal is less affected by noise and can be transmitted reliably without loss of the signal information from the mobile device 24 to the vehicle-mounted device 23.

For example, the ASK modulated signal X is assumed to have the header with the continuous amplitude at the predetermined level or greater and the data portion indicating the instruction data for having the mobile device 24 transmit the signal Y. In this case, if the negative feedback control of the AGC circuit 25 is performed during the data portion of the signal X, the instruction data is not reproduced accurately in the mobile device 24, and the signal Y may not be transmitted to the vehicle-mounted device 23. However, with the AGC circuit 25 of the present invention, the gain of the variable gain amplification circuit 1 of the mobile device 24 takes on a constant value in the header as described above. As a result, the negative feedback control of the AGC circuit 25 is not performed during the data portion including information in terms of changes in amplitude, and the amplified signal amp_in that has been amplified only in the amplitude is output to the amplification circuit 2. The amplified signal amp_in is amplified with the fixed gain of the amplification circuit 2 to be the output signal det_in. The output signal det_in is input to the circuit block at the subsequent stage and the detection circuit 3. That is, the data portion including information in terms of changes in amplitude is input into the circuit block, and the instruction data indicated by the data portion is processed accurately by the circuit block. The FSK modulated signal Y can be reliably transmitted from the mobile device 24 to the vehicle-mounted device 23.

==Other Embodiments==

Although the AGC circuit according to the present invention has been described above, the above description is for the purpose of facilitating the understanding of the present invention and does not limit the present invention. The present invention may be modified and altered without departing from the spirit thereof and the present invention includes the equivalents thereof.

<<Reference Voltage Vref>>

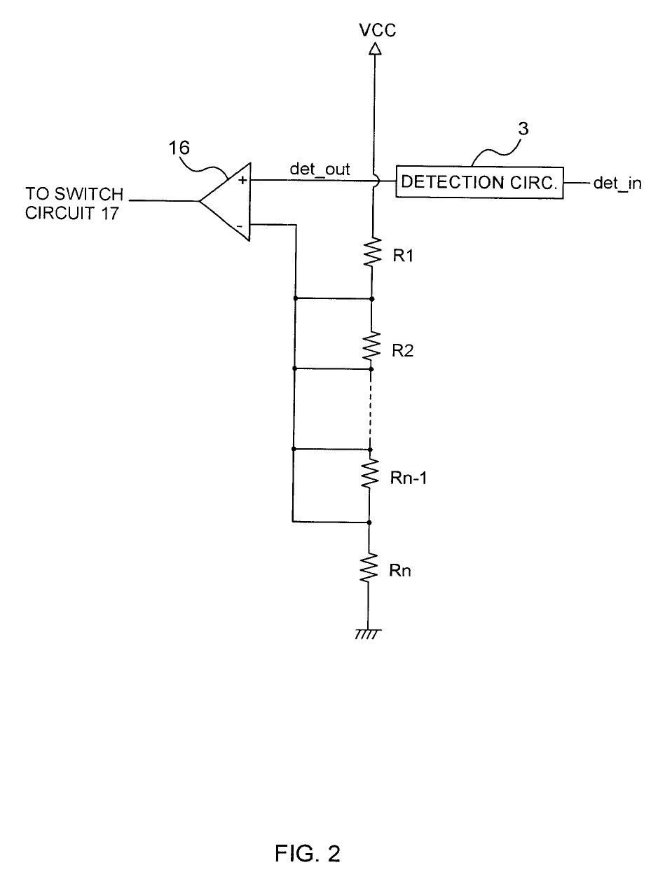

Although the reference voltage Vref based on the reference voltage data is applied to the −input terminal of the differential amplification circuit 16 via the EEPROM 9, the register 10, and the DAC 11 in the above embodiment, this is not a limitation. For example, a trimming resistor shown in FIG. 2 may be provided.

As shown in FIG. 2, the trimming resistor has resistors R1 to Rn serially connected, and the respective connecting points of the resistor R1 to Rn are connected by a short-circuiting line. The short-circuiting line is connected to the −input terminal of the differential amplification circuit 16. A voltage Vcc is applied to the resistor R1 at one end which is not connected to the resistor R2, and the resistor Rn is grounded at one end which is not connected to the resistor Rn-1.

By disconnecting the short-circuiting lines selectively, the reference voltage Vref can be generated for setting the amplitude of the output signal det_in at a desired level.

<<Generation of Clocks>>

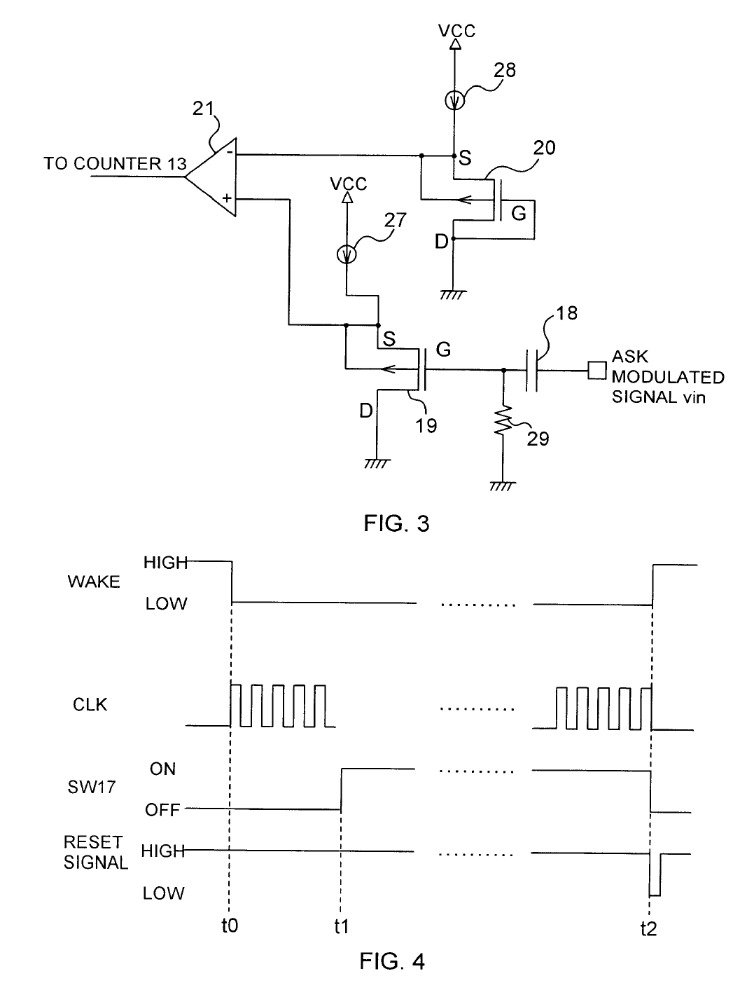

Although whether the count value of the counter 13, which uses the clocks generated by the binarization circuit 26 based on the oscillation of the RC oscillation circuit 12, has attained the setting value or not is determined in the above embodiment, this is not a limitation. For example, a frequency (e.g., 125 kHz) of the header of the ASK modulated signal vin may be used. FIG. 3 shows a clock extraction circuit for where the frequency of the header of the ASK modulated signal vin is the same as the frequency of the clocks from the binarization circuit 26. In the following description, it is assumed that the ASK modulated signal vin changes with, e.g., 1.2 V as its center.

The clock extraction circuit is constituted by a comparator circuit 21, P-channel MOSFETs (Metal Oxide Semiconductor Field Effect Transistors) 19, 20, a coupling capacitor 18, constant current sources 27, 28, and a high resistor 29. The ASK modulated signal vin is input to one end of the coupling capacitor 18, and the other end is connected to the gate of the P-channel MOSFET 19 and the high resistor 29 for grounding at DC. The both P-channel MOSFETs 19, 20 are source-followered and their drains are grounded. The source of the P-channel MOSFET 19 is connected to the +input terminal of the comparator circuit 21. The source of the P-channel MOSFET 19 is also connected to the constant current source 27 for generating a direct-current voltage of 1.2 V, for example. The source of the P-channel MOSFET 20 is connected to the −input terminal of the comparator circuit 21. The source of the P-channel MOSFET 20 is also connected to the constant current source 28 for generating a direct-current voltage of 1.2 V, which is at the same level as the source of the P-channel MOSFET 19, and its gate is grounded.

The direct-current component of the ASK modulated signal vin is removed by the coupling capacitor 18 and the alternating-current component of the ASK modulated signal vin is applied to the gate of the P-channel MOSFET 19. In the P-channel MOSFET 19, the ASK modulated signal vin is superimposed on the direct-current voltage of 1.2 V and applied to the +input terminal of the comparator circuit 21. The 1.2-V direct-current voltage from the P-channel MOSFET 20 is applied to the −input terminal of the comparator circuit 21.

The comparator circuit 21 outputs a high level when the input through the +input terminal is greater than the input through the −input terminal (1.2 V) and the comparator circuit 21 outputs a low level when the input through the +input terminal is smaller than the input through the −input terminal. As a result, the comparator circuit 21 outputs clocks at the same frequency as the frequency of the ASK modulated signal vin.

In order to make the AGC circuit 25 of the present invention integrated, at least three patterns are conceivable for the configuration of the AGC circuit 25. In a first pattern, the AGC circuit 25 is constituted by the variable gain amplification circuit 1, the amplification circuit 2, the detection circuit 3, the differential amplification circuit 16, the switch circuits 7, 17, and the capacitor 8. Other components are disposed externally and are connected via terminals to the integrated AGC circuit 25. In a second pattern, the AGC circuit 25 is constituted by the components of the first pattern and in addition the above clock extraction circuit (or RC oscillation circuit 12, binarization circuit 26), the signal amplitude detection circuit 5, the counter 13, the register 14, and coincidence detection circuit 15. Similarly, other components are disposed externally and are connected via terminals to the integrated AGC circuit 25. In a third pattern, the AGC circuit 25 is constituted by the components of the second pattern and in addition the above trimming resistor (or EEPROM 9, register 10, DAC 11). Note that the setting of the reference voltage with use of the trimming resistor is performed before making the AGC circuit 25 integrated. Similarly, other components are disposed externally and are connected via terminals to the integrated AGC circuit 25. The capacitor 8 can be an external component in any one of the first, second, and third patterns described above. As a result, the gain of the variable gain amplification circuit 1 can be set arbitrarily by changing the capacity of the capacitor 8.

According to the above embodiment, before the charge voltage of the capacitor 8 becomes a constant voltage, the gain of the variable gain amplification circuit 1 can be changed depending on the charged voltage so as to make the detected voltage det_out equal to the reference voltage Vref. As a result, the amplitude of the output signal det_in can be made constant. After the charged voltage of the capacitor 8 becomes a constant voltage, the switch circuit 17 is opened to forbid the charging of the capacitor 8, thereby setting the gain of the variable gain amplification circuit 1 to a constant value. As a result, for example, if the input signal vga_in including information in amplitude such as the ASK demodulation signal vin is input to the variable gain amplification circuit 1, the signal is amplified in such a way as not to make the amplitude of the output signal det_in constant. That is, the signal is amplified without loss of the information of the amplitude and is output to the block circuit at the subsequent stage.

By closing the switch circuit 7 before the capacitor 8 is charged with the error voltage from the differential amplification circuit 16, the charged voltage of the capacitor 8 can be discharged. As a result, the charged voltage of the capacitor 8 can be made constant more reliably.

When the switch circuit 17 is closed, the error voltage can be directly applied to the capacitor 8, and the charging operation can be performed on the capacitor 8 so as to reflect the difference voltage between the detected voltage det_out and the reference voltage Vref. As a result, the gain of the variable gain amplification circuit 1 can be further optimized.

By setting the setting value to a time period required for charging at least the capacitor 8 up to a constant voltage, the switch circuit 17 can be opened at more reliable timing.

By using the RC oscillation circuit 12 having a shorter start time from power-on to the stable oscillation, the count operation can be quickly performed by the counter 13.

By using the coincidence detection circuit 15 that detects the coincidence between the count value of the counter 13 and the setting value of the register 14 corresponding to the comparison data, the output can be more reliably performed at least when the count value has attained the setting value indicating a period required for charging the capacitor 8 up to a constant voltage. If the period required for charging the capacitor 8 up to the constant voltage varies, the setting value corresponding to the period can be set in the register 14, and changes in the period can be dealt with more flexibly.

The reference voltage Vref based on the reference voltage data stored in the EEPROM 9 can be reliably applied to the differential amplification circuit 16. For example, by changing the reference voltage data with a ROM writer, etc., a desired reference voltage Vref can be applied to the differential amplification circuit 16.

The RC oscillation circuit 12 can start the oscillation operation according to the low-level WAKE signal indicating that the amplitude of the input signal vga_in is at a predetermined level or greater. As a result, when the ASK modulated signal vin is input, each component of the AGC circuit 25 can start operating. That is, the ASK modulated signal vin including information in amplitude can be reliably processed. In the data portion period (t1 to t2), the ASK modulated signal vin can be amplified by the variable gain amplification circuit 1 without the gain being changed, and the output signal det_in can be output without loss of the information in amplitude.

According to the other embodiment described above, by using the trimming resistor, the costs of the AGC circuit 25 can be reduced as compared to the configuration including the EEPROM 9, the register 10, and the DAC 11. The circuit configuration of the AGC circuit 25 can be prevented from being complicated.

By using the clock extraction circuit, more suitable clocks can be generated for the input signal vin. As a result, the AGC circuit 25 can perform the above control accurately on the input signal vin, and the accurate output signal det_in can be output to the circuit block at the subsequent block.

While the illustrative and presently preferred embodiments of the present invention have been described in detail herein, it is to be understood that the inventive concepts may be otherwise variously embodied and employed and that the appended claims are intended to be construed to include such variations except insofar as limited by the prior art.

What is claimed is:

1. An AGC circuit comprising:
a variable gain amplification circuit that has a gain set variably and amplifies an input signal with the gain;
a detection circuit that detects an output signal amplified by the variable gain amplification circuit;
an error amplification circuit that outputs an error voltage corresponding to a difference voltage between a detected voltage indicating amplitude of the output signal detected by the detection circuit and a reference voltage for fixing the amplitude of the output signal to be at a predetermined degree;
a capacitor that is charged depending on the error voltage and holds a setting voltage for fixing the gain of the variable gain amplification circuit to be at a constant value, the setting voltage being applied to a gain setting input of the variable gain amplification circuit; and
a charging switch circuit that is closed to permit an operation of charging the capacitor until a charged voltage of the capacitor reaches the setting voltage and is opened to forbid the operation of charging the capacitor after the charged voltage of the capacitor reaches the setting voltage.

2. The AGC circuit of claim 1, further comprising:
a discharging switch circuit that is closed to discharge the voltage of the capacitor before the charging switch circuit is closed.

3. The AGC circuit of claim 2,
wherein the charging switch circuit is disposed in between the output of the error amplification circuit and one end of the capacitor generating the setting voltage.

4. The AGC circuit of claim 3, further comprising:
a counter circuit that counts clocks of a predetermined frequency and controls the opening/closing of the charging switch circuit by its output depending on the count,
wherein the charging switch circuit is closed by the output while the counter circuit counts from an initial value to a predetermined value and is opened by the output after the counter circuit has counted up to the predetermined value, and
wherein the predetermined value is a value indicating a time period required at least for charging the capacitor up to the setting voltage.

5. The AGC circuit of claim 4, further comprising:
an RC oscillation circuit for generating the clocks of the predetermined frequency.

6. The AGC circuit of claim 4,
wherein the input signal is an ASK (Amplitude Shift Keying) modulated signal with the predetermined frequency,
the AGC circuit further comprising a comparator circuit that compares a voltage value which changes with the predetermined frequency of the input signal and a direct-current voltage value indicating the center of the amplitude of the input signal, thereby generating the clocks of the predetermined frequency.

7. The AGC circuit of claim 4,
wherein the counter circuit includes a counter that counts the clocks of the predetermined frequency, a comparison register that is set to the predetermined value, and a coincidence detection circuit that detects coincidence between the count of the counter and a setting value of the comparison register, and
wherein the charging switch circuit is closed by the output before the coincidence detection circuit detects the coincidence between the count of the counter and the setting value of the comparison register and is opened by the output when the coincidence detection circuit detects the coincidence between the count of the counter and the setting value of the comparison register.

8. The AGC circuit of claim 1, further comprising:
a trimming resistor that can selectively generate the reference voltage.

9. The AGC circuit of claim 1, further comprising:
a nonvolatile memory that stores at least one reference voltage data indicating a value for the reference voltage;
a register that is set to one reference voltage data read from the nonvolatile memory; and
a DA converter that converts the reference voltage data set in the register into a voltage and applies the voltage as the reference voltage to the error amplification circuit.

10. The AGC circuit of claim 5, further comprising an amplitude detection circuit,
wherein the input signal is an ASK (Amplitude Shift Keying) modulated signal having a header with a constant amplitude that continues for a predetermined period,
the amplitude detection circuit detects the start of changes with the constant amplitude of the header to output an operation start signal, and
the RC oscillation circuit starts operating according to the operation start signal.

11. The AGC circuit of claim 6, comprising an amplitude detection circuit,
wherein the input signal is an ASK (Amplitude Shift Keying) modulated signal having the predetermined frequency and a header with a constant amplitude that continues for a predetermined period,
the amplitude detection circuit detects the start of changes with the constant amplitude of the header to output an operation start signal, and
the comparator circuit starts operating according to the operation start signal.
